(19) United States
(12) Patent Application Publication
(10) Pub. No.: US 2025/0068389 A1
(43) Pub. Date: Feb. 27, 2025

(54) Electronic Wireless Binary Transmitter to a Electronic Receiver

(71) Applicant: Reginald Keith Sapp, CLINTON, MD (US)

(72) Inventor: Reginald Keith Sapp, CLINTON, MD (US)

(21) Appl. No.: 18/745,338

(22) Filed: Jun. 17, 2024

(51) Int. Cl. G06F 7/40

(52) U.S. Cl. CPC G06F 7/405

(57) ABSTRACT

The Binary Transmitter and Receiver is a circuit for Binary information to travel through Air without wires from the end out FIG. 4 without wires.

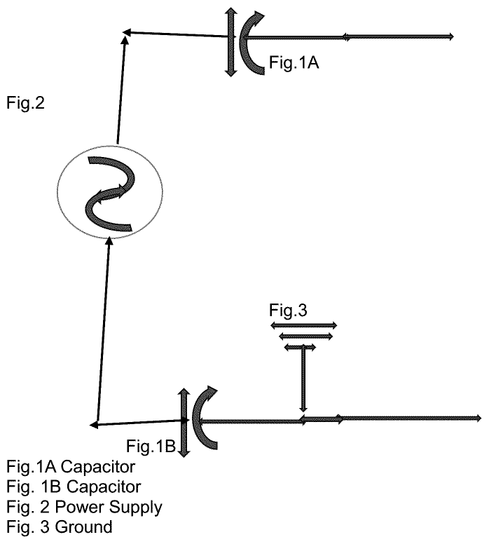

The transmitter circuit and Receiver is powered by FIG. 2 (volt, current, amp), FIG. 1 (capacitance), and resistance with its information of 0 or 1 in a series or parallel circuit or both.

It was tested in wood (a box). To be housed in plastic (a polymer), tin, copper, metal or Metal alloy. To function with keys from 0-9 key punch, A-Z and special character's key punch, and other inputs and outputs

That uses switches, nor-gates, and-gate, diodes, resistors and capacitors FIGS. 1A and 1B for a functional transmitter and a functional receiver.

Mini technology is required in models for mobile traveling with Lithium batteries or non-Lithium batteries for its power source.

This electronic device works with controls to an analog/digital application a Binary Signal power and AC power FIG. 2. The device is a binary signal transmitter that uses machine binary language (A binary sinewave) to transmit and AC to fall across the capacitors in FIG. 1, and across ground FIG. 3. its binary code to a binary receiver decodes without the use of wires between the transmitter and the receiver

To transmit binary code through the end circuit to out. A transmission is created at the end of the capacitors FIG. 1 which is binary out. This leads to a binary receiver decoder without the use of wires between the transmitter and the receiver.

The sinewave transmitter can be AC plug in, AC ION battery or a DC to AC converter circuit at a Hertz value and 5+ volts in strength. The binary is manually pressed on the transmitter controller keypad creating a digital transfer effect.

It is configured with varies electronic components in a structure for input by pressing the keypads.

1. It was tested that a sinewave binary wave will jump it spark to another circuit transmit out it signal FIG. 4 to a binary receiver circuit. Also, we found that the use of electricity jumps across a wire without being connected to each other helps the transmitter across a wire without being connected to each other. The sinewave Binary wave is code of binary passing through space coded as a binary wave passing through space.
It was used on a telephone from it was connection to the circuit and jumps from the circuit to the detached phone binary wave circuit and AC at the wall to the circuit connection at FIG. 2.
The output at FIG. 4 binary wave transmitted to the detached phone. The binary wave from the wall and AC power FIG. 2 connected to the phone while being wireless was able to communicate through a door at a distance.
